(19) United States
(12) Patent Application Publication
(10) Pub. No.: US 2026/0239331 A1
(43) Pub. Date: Aug. 13, 2026

(54) HANDLING OF SCHEDULING REQUESTS (SR)

(71) Applicant: Apple Inc., Cupertino, CA (US)

(72) Inventors: Ping-Heng KUO, London (GB); Ralf ROSSBACH, Munich (DE); Fangli XU, Beijing (CN)

(21) Appl. No.: 19/154,519

(22) PCT Filed: Feb. 2, 2024
(86) PCT No.: PCT/US2024/014314

§ 371 Date: Aug. 7, 2025

Related U.S. Application Data
(60) Provisional application No. 63/483,841, filed on Feb. 8, 2023.

(51) Int. Cl. H04W 72/1263; H04W 28/02

(52) U.S. Cl. CPC H04W 72/1263; H04W 28/0278

(57) ABSTRACT

The present application relates to improved user equipment (UE) behaviors in instances of buffer status reports (BSRs) or other Medium Access Control (MAC) Control Elements (CE)s being triggered by particular events, such as packet discarding or long packet queuing delay times. In some cases, a UE may avoid unnecessary scheduling request (SR) signaling, e.g., if there is already a pending SR, the UE may cancel the SR if the data in the buffer is no longer available because of packet discarding. In other cases, if there is already a pending SR, the UE may signal the pending SR as soon as possible to a base station and provide a buffer status update. When a BSR is triggered by long packet queueing delay and there is already a pending SR, the UE may also want to signal the pending SR as soon as possible to provide packet queueing delay time information.

### TECHNICAL FIELD

The present application relates to wireless devices and wireless networks, including user devices, terminals, circuits, computer-readable media, and methods for the handling of scheduling requests (SRs) in situations of packet discarding and/or long packet queuing delay times.

### BACKGROUND

Wireless communication systems are rapidly growing in usage. In recent years, wireless devices such as smart phones and tablet computers have become increasingly sophisticated. In addition to supporting telephone calls, many mobile devices now provide access to the Internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), Long-Term Evolution (LTE), LTE Advanced (LTE-A), HSPA, 3GPP2 CDMA2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

In particular, buffer status reports (BSRs) are important mechanisms for a user equipment (UE) to be able to inform a base station regarding an amount of uplink data that has arrived in a buffer of the UE. The base station may use this information to allocate uplink resources to accommodate the buffered data. Details about using buffer status reports in Third Generation Partnership Project (3GPP) networks is provided in 3GPP Technical Specification 38.300 v17.2.0 (2022 Oct. 1).

Media flows can now be carried over wireless networks, but the transmission of media content can be especially challenging for applications with high-throughput and low latency requirements, such as video conferencing and so-called Extended Reality (XR) applications, wherein XR is defined as an umbrella term referring to all aspects of Virtual Reality (VR), Augmented Reality (AR), and/or Mixed Reality (MR). Wireless networks can implement techniques to improve network capacity and energy efficiency, as well as reduce the impact of packet losses on users.

For example, a network should be able to handle groups of packets based on how critical they are to the user experience. Some groups of data packets hold application data units that are handled together (e.g., decoded) by the application. 3GPP defines the term “Protocol Data Unit set” (or, “PDU set”) to identify these groups of data packets carrying the payload of an application data unit, which can correspond to the data packets of a Network Application Layer (NAL) unit. Application data units can depend on other application data units to be handled or decoded by the application (e.g., P-frames depend on I-frames, and higher layers depend on lower layers, etc.).

The network can perform differentiated handling of groups of data packets, e.g., to prioritize the transmission of some groups of packets over others in cases of network congestion. The network can also selectively drop data packets that depend on an already lost application data unit. The network can also strategically limit wake-up times (i.e., of radios) to transmit and receive data. Thus, a packet scheduler can benefit from information on the size and periodicity of traffic, as well as the delay budget and expected jitter for a particular application. Efficient handling of high-throughput and low-latency traffic may therefore include differentiated handling of groups of packets, as well as the configuring of lower-layer scheduling.

In the case of high-throughput and low latency applications, such as XR applications, it has been proposed that BSRs should be enhanced to include information such as packet queueing delay time and/or remaining until an impending delivery deadline. Such information would allow a base station allocate uplink resource in a timelier manner. In light of this, there may be new BSR triggering events relating to packet discarding or long queueing times. BSRs of these types should ideally be sent to the base station quite urgently.

### SUMMARY

In accordance with one or more embodiments, a method of operating a user equipment (UE) is disclosed herein, the method comprising: detecting a condition of a buffer of the UE that corresponds to a first buffer condition; determining a first logical channel (LCH) associated with the first buffer condition; determining whether there is a first scheduling request (SR) pending for the first LCH; and, in response to determining that there is a first SR pending for the first LCH, modifying at least one parameter of the first SR pending for the first LCH; whereas, in response to determining that there is not a first SR pending for the first LCH, triggering a second SR for the first LCH, wherein the second SR has at least one parameter modified with respect to parameters for a default SR configuration corresponding to the first LCH.

According to some aspects, the first buffer condition triggers a first buffer status report (BSR) or other Medium Access Control (MAC) Control Element (CE), which may be transmitted to a base station. In some aspects, the first BSR may report information for only the first LCH, while, in other aspects, the first BSR may report information for each LCH in a logical channel group (LCG) that the first LCH is associated with. According to some such aspects, triggering the second SR further comprises triggering the second SR to obtain an uplink (UL) resource allocation for the first BSR. Triggering of the second SR may, in some aspects, be performed in response to determining there is no Uplink Shared Channel (UL-SCH) available for the UE to use.

According to other aspects, the first buffer condition may based on at least one of: (a) a determination of whether all protocol data units (PDUs) in a buffered PDU set are required by an application; (b) a comparison of a remaining time until a delivery deadline of buffered data to a predetermined threshold; (c) a comparison of a queuing time of buffered data to a predetermined threshold; (d) a comparison of an amount of buffered data to a predetermined threshold; (e) an importance or priority associated with a buffered PDU set; (f) whether packet discarding is configured for a buffered PDU set or a radio bearer corresponding to the buffered PDU set; (g) whether a packet discarding event has occurred; (h) a comparison of an amount of discarded data to a predetermined threshold; (i) a comparison of an amount of remaining buffered data after a packet discarding event has occurred to a predetermined threshold; or (j) a determination of whether an amount of buffered data remaining after a packet discarding event is zero.

According to still other aspects, the method further comprises determining that the first buffer condition comprises a packet queueing delay condition or a packet discarding condition. In instances when the first buffer condition relates to packet queueing delay, the method may further comprise: sending packet queuing delay time information to a base station. In some such instances, the first buffer condition may indicate at least one of the following conditions: (a) that a queueing delay for buffered data has exceeded a threshold; or (b) that an amount of remaining time until a delivery deadline for the buffered data is smaller than a threshold (wherein, e.g., the delivery deadline for the buffered data is derived based, at least in part, on a delay budget associated with one or more packets within the buffered data).

According to still other aspects, modifying at least one parameter of the first SR pending for the first LCH comprises at least one of: (a) stopping a prohibit timer of the first SR; (b) cancelling the first SR; (c) triggering a new SR having a different SR configuration than the first SR (e.g., a shorter prohibit timer); (d) modifying the Physical Uplink Control Channel (PUCCH) configuration used to signal the first SR; or (e) resetting a value of a counter for the first SR.

According to still other aspects, signaling the first SR may be done at a next available opportunity, i.e., whether or not an SR prohibit timer for the first SR is still running.

According to still other aspects, a Medium Access Control (MAC) layer may instruct the UE to use the physical layer (PHY) to signal the first SR to a base station directly.

According to still other aspects, the second SR having at least one parameter modified with respect to parameters for a default SR configuration comprises at least one of: (a) the second SR having a different SR configuration than the default SR configuration; (b) the second SR having a different SR prohibit timer configuration (e.g., a shorter prohibit timer) than the default SR configuration; or (c) the second SR using a different PUCCH configuration than the default SR configuration.

According to yet other aspects, the buffer may include traffic for a plurality of LCHs of one or more logical channel groups (LCGs), wherein the first buffer condition is associated with one or more LCHs of the plurality of LCHs or is associated with any of the plurality of LCHs.

The various methods and techniques summarized in this section may likewise be performed by a UE device comprising: a receiver; a transmitter; and a processor configured to perform any of the various methods and techniques summarized herein. The various methods and techniques summarized in this section may likewise be stored as instructions in a non-volatile computer-readable medium, wherein the instructions, when executed, cause the performance of the various methods and techniques summarized herein.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates a diagram detailing a method of exchanging a buffer status report (BSR) and uplink grant between a UE and a base station, according to some aspects.

FIG. 6 illustrates exemplary PDU sets containing different numbers of data packets, according to some aspects.

FIG. 7 illustrates a flow diagram detailing a method of handling scheduling request (SRs) when a BSR is triggered by packet discarding or long packet queueing delay, according to some aspects.

FIG. 8 illustrates various diagrams detailing exemplary SR configuration for handling BSRs triggered by packet discarding or long packet queueing delay, according to some aspects.

FIG. 9 is a flowchart detailing a method of handling SRs when a BSR is triggered by packet discarding or long packet queueing delay, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

The present application relates to improved user equipment (UE) behaviors in instances of buffer status reports (BSRs) being triggered by events relating to packet discarding or long packet queuing delay times. In some cases, a UE may avoid unnecessary scheduling request (SR) signaling. For example, if there is already a pending SR, the UE may cancel the SR if the data in the buffer is no longer available because of packet discarding. In other cases when there is already a pending SR, the UE may signal the pending SR as soon as possible in order to send a BSR to a base station and provide a timely buffer status update. When a BSR is triggered by long packet queueing delay times and there is already a pending SR, the UE may also want to signal the pending SR as soon as possible to send a Medium Access Control (MAC) Control Element (CE), such as a BSR, to the base station and provide packet queueing delay time information. (Note that, in some implementations, the packet queueing delay time information could be conveyed to the network by other types of MAC CEs as well, i.e., MAC CEs other than BSR.) If there is no pending SR, the UE may trigger a new SR to obtain a suitable uplink (UL) resource for the BSR.

The following is a glossary of additional terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

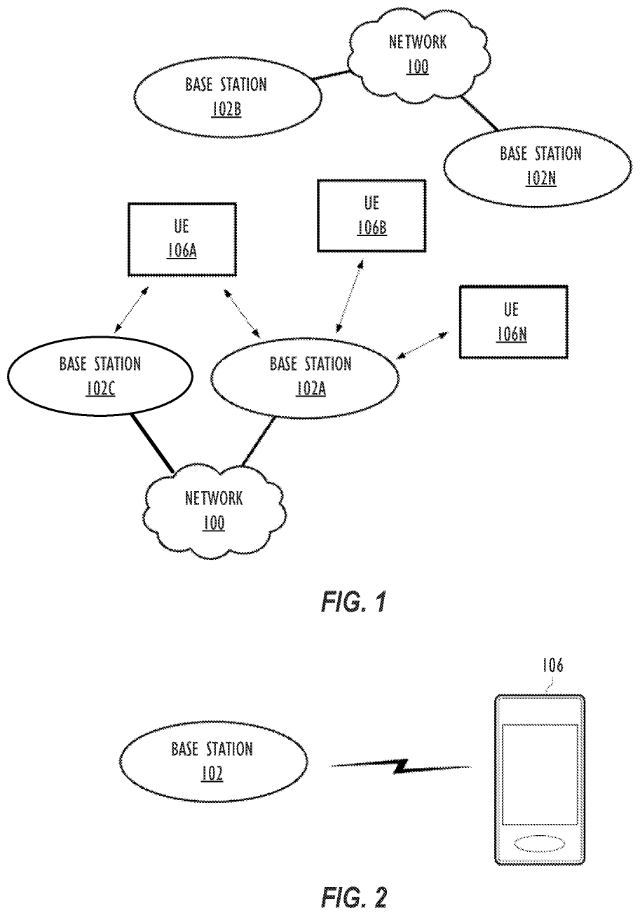

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using an SL interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHz Intelligent Transport Systems (ITS) band to provide very low latency communications required for high speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1xRTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

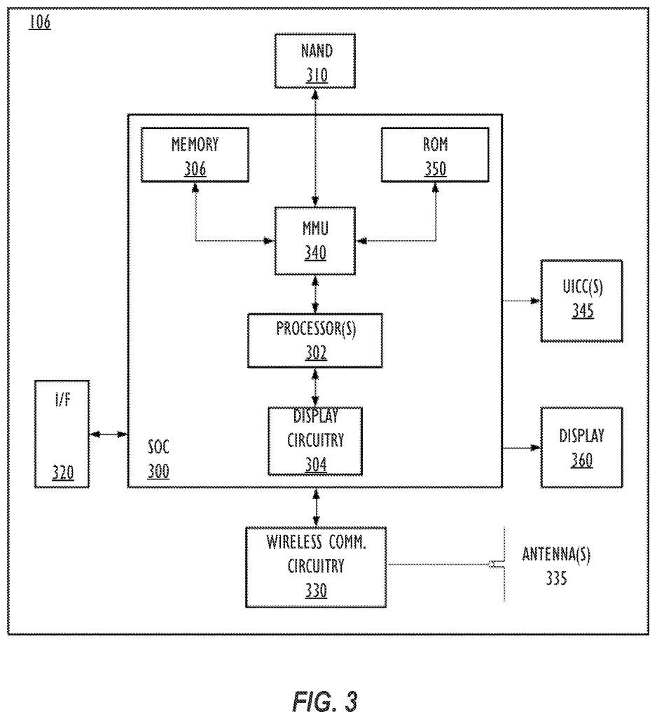

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

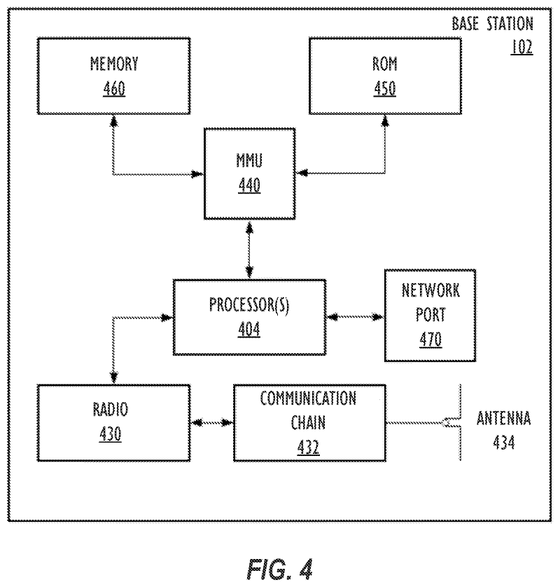

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

### Buffer Status Reports

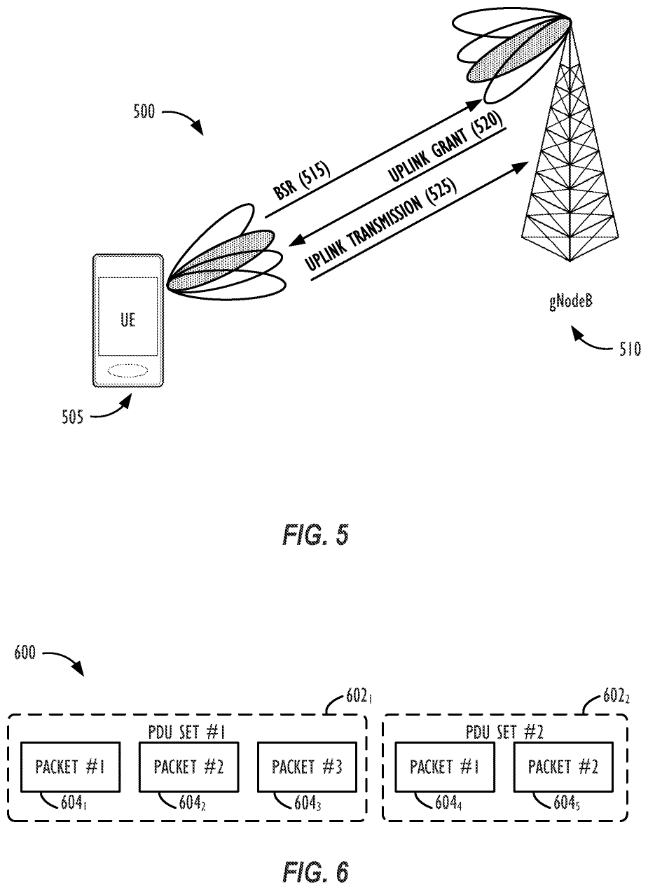

Turning now to FIG. 5, a diagram 500 detailing a method of exchanging a buffer status report (BSR) 515 and uplink grant 520 between a UE 505 and a base station (i.e., gNodeB 510) is illustrated, according to some aspects. At a high level, the UE 505 may send a buffer status report (BSR) 515 to the base station 510 to indicate an amount of uplink data that the UE has to transmit. The BSR 515 may be transmitted as a media access control (MAC) control element (CE) on a physical uplink shared channel (PUSCH). The BSR 515 may be associated with a logical channel group (LCG) having one or more logical channels (LCHs). Upon receiving the BSR 515, the base station 510 may determine an appropriate amount of uplink resources for the UE. The base station 510 may then transmit an uplink grant 520 to the UE 505. The UE 505 may then use the UL grant for a subsequent uplink transmissions 525.

In various embodiments, the UE may transmit a regular BSR, a periodic BSR, or a padding BSR. A regular BSR may be triggered in the event new uplink data of an LCH of an LCG becomes available in a MAC buffer and either: the LCH has a higher priority than any other LCH having buffered data; or no other LCH has buffered data. A regular BSR may also be triggered in the event a retransmit BSR timer (i.e., retxBSR-Timer) expires and an LCH includes buffered data to be transmitted. The retransmit BSR timer may be used to avoid a deadlock situation that may occur if the base station fails to receive a BSR, but the UE believes the BSR transmission was successful. Thus, the retransmit BSR timer provides a limited period of time the UE will wait for the uplink grant before retransmitting the BSR. The retransmit BSR timer is started when a BSR is multiplexed into a MAC PDU.

A periodic BSR may be triggered upon expiration of a periodic BSR timer (i.e., periodicBSR-Timer). A padding BSR may be triggered if allocated uplink resources have a number of padding bits equal to or exceeding a size of the BSR. Thus, the padding BSR may opportunistically utilize unused uplink capacity.

Existing networks may include a number of BSR formats, including a short BSR format (fixed size), an extended short BSR format (fixed size), a long BSR format (variable size), an extended long BSR format (variable size), a short truncated BSR format (fixed size), a long truncated BSR format (variable size), and an extended long truncated BSR format (variable size). Selection between these formats in existing networks is fixed in clause 5.4.5 of 3GPP TS 38.321. The selection may be based on a number of LCGs that have data available for transmission, whether the MAC entity has a logical channel group IAB extension (i.e., logicalChannelGroup-IAB-Ext) configured, and, for padding BSR, the number of available padding bits compared to the size of various of the formats.

Traffic types are evolving to accommodate new use cases in developing cellular networks. For example, as mentioned above, efforts are being undertaken to improve RAN operation to support traffic having characteristics associated with extended reality (XR) traffic to provide, for example, high throughput, low-latency, and high reliability. Various enhancements to SR and BSR operation may be used to improve capacity and delay times for data transmission in XR application use cases. While some embodiments are described with reference to XR traffic, other embodiments may apply similar concepts to other types of traffic.

According to some aspects, the BSR (or other MAC CE that may be used in a given implementation) may be enhanced for XR use cases by including additional types of information. Existing BSRs only provide information about a buffer's size. In order to facilitate delay-aware scheduling for XR traffic that has latency constraints, the BSR may further include information relating to delay status of the buffered data. For example, the BSR may include an indication of how long the data has been queued or an amount of time that remains until a delivery deadline.

### Protocol Data Unit (PDU) Sets and Quality of Service (QoS) Handling for Delay-Sensitive Traffic

Turning now to FIG. 6, an example 600 of exemplary PDU sets 602 containing different numbers of data packets 604 are illustrated, according to some aspects. For example, a PDU set #1 (602₁) may contain packets 604₁, 604₂, and 604₃, and a PDU set #2 (602₂) may contain packets 604₄ and 604₅. XR traffic is one example of wireless data that may operate based on a PDU set. As illustrated in FIG. 6, a PDU set, may correspond to an application data unit, which may include a plurality of packets/PDUs. A user plane function (UPF) may identify a PDU set based on a PDU set sequence number (SN), a start/end PDU of the PDU set, a PDU SN within a PDU set, or a number of PDUs within a PDU set.

A quality of service (QoS) flow may be identified using a QoS flow ID, and each PDU set within the QoS flow may be identified using the PDU set SN. Each QoS flow can be used to deliver one or more PDU sets. The UPF may further identify information relating to the PDU set, for example, a PDU set importance or a PDU set dependency. The UPF may provide the information relating to PDU sets to a RAN. QoS parameters for PDU set-based QoS handling may include a PDU set delay budget (PSDB), a PDU set error rate (PSER), whether to drop a PDU set in case a PSDB is exceeded, whether all PDUs are needed for usage of a PDU set by an application layer, and a PDU set priority. A network could configure a UE to map a first QoS flow, e.g., QoS Flow 1, to a first radio bearer, e.g., Radio Bearer 1, and then map a second QoS flow, e.g., QoS Flow 2) to a second radio bearer, e.g., Radio Bearer 2, and then the network could configure different radio-related configurations and/or parameterizations for the different radio bearers (e.g., Radio Bearer 1 and Radio Bearer 2). The characteristics of a buffered PDU set (for example, an importance level of the PDU set) may also be indicated in a BSR (or other form of MAC CE, as may be used in a given implementation).

In XR applications (or other time-sensitive applications), there is the chance that some packets of a PDU set may be discarded even before they are transmitted, e.g., if the PSDB is exceeded and/or if all PDUs are not needed for the usage of PDU Set by application layer, etc. Other scenarios where proactive packet dropping may occur include: (1) if all packets in a PDU set must be delivered successfully to be useful for the application layer, then it would not be necessary to transmit all packets of a PDU set if one or more of them have already failed; (2) if at least one critical/essential PDU set has already failed, there is no need to transmit the remaining packets in the same PDU set; (3) if it is sufficient for the application layer as long as a certain portion of a PDU set is received successfully, then the transmitter may drop the remaining packets in a PDU set to save power/resources once the required portion of the PDU set has been successfully delivered; (4) if there is interdependence between different PDU sets, then the transmitter may determine to drop or continue transmitting a PDU set based on the status of another interdependent PDU set; or (5) the transmitter may proactively discard some packets in order to alleviate traffic congestion.

When a decision about packet discarding is made—regardless of the reasons for packet discarding—the packets from one or more PDU sets that are still queued in the LCH buffer may be flushed away. Therefore, the UL buffer status would experience a changed buffer condition (e.g., the buffer may become less full or even empty) when the packet discarding occurred. It would be important for the gNB to know about this change in buffer condition (i.e., due to the packet discarding) as soon as possible. Otherwise, the gNB may allocate radio resource based on outdated knowledge about the buffer's status (i.e., the buffer's status before the most recent packet discarding event had occurred).

On the other hand, traffic in many XR applications is delay-sensitive and needs to be delivered within a certain time budget (e.g., a PSDB) in order for it to be useful to an application. To achieve delay-aware scheduling, it has been proposed that buffer status reporting should be enhanced to include additional information, such as queueing delay time and/or remaining time until a delivery deadline. Such information would allow the gNB to allocate uplink resources in a more timely fashion. In light of such proposals, there may be new triggering events for BSRs (or other MAC CEs) related to delay information, such as queueing time. For example, a BSR including queueing delay information may be triggered when the buffered data has been waiting in the buffer for a certain amount of time. This type of BSR should be sent quite urgently, so that the gNB can know that the buffered data is time critical.

Scheduling requests (SRs) may be triggered and become pending by packet arrival at a logical channel (LCH), wherein the UE can send the SR to get a Physical Uplink Shared Channel (PUSCH) allocation, in order to send a BSR. Therefore, currently, a SR that is triggered by BSR is only cancelled when a BSR containing the corresponding buffer is included into a Medium Access Control (MAC) Protocol Data Unit (PDU) for transmission. Otherwise, it is considered “pending,” and the UE will continue signaling these SR in the corresponding PUCCH. Once the SR is signaled on a PUCCH, the UE should start (or re-start) the sr-ProhibitTimer (wherein the UE is not allowed to send the SR if the sr-ProhibitTimer is running). Thus, when the SR is cancelled (e.g., when the BSR is multiplexed into a MAC PDU), the UE should also stop the running sr-ProhibitTimer. The UE should increment an SR counter when an SR is signaled. Then, when the SR counter reaches sr-TransMax, the UE may no longer be able to signal the SR. Some example solutions for improved handling of SRs upon the occurrence of certain types of special events, such as packet discarding or long packet queueing delay, are described below. However, it is to be understood that the solutions described herein are not intended to be limited to these types of special events, and they could likewise be employed in response to the occurrence of other types of special events (e.g., when a UE receives specific types of downlink data, control signals, or other types of messages), as may be desired in a given implementation.

### Example Solutions for Improved Handling of SRs Upon Packet Discarding or Long Packet Queueing Delay

Whenever a packet discarding event occurs, there may be two potential intended UE behaviors: (1) have the UE avoid any unnecessary SR signaling; or (2) send a new BSR to update the base station regarding the buffer status. Regarding potential UE behavior (1) in response to packet discarding, if there is already a pending SR, the UE may want to cancel the SR if the data in the buffer is no longer available because of the packet discarding. However, if there is no pending SR, then no action may be needed from the UE. Regarding potential UE behavior (2) in response to packet discarding, if there is already a pending SR, the UE may want to signal this pending SR as soon as possible in order to send the BSR to update the base station regarding the buffer status. If, however, there is no pending SR, the UE may trigger a SR to get an UL resource for the BSR.

Whenever a BSR is triggered by a long queueing delay, the potential intended UE behavior may comprise the following: if there is already a pending SR, the UE may want to signal this pending SR as soon as possible in order to send a BSR and provide queueing delay time information; whereas, if there is no pending SR, the UE may trigger a SR to get a UL resource for BSR. The UE may also preferably want to send this SR as soon as possible. Thus, described herein are various solutions for handling SRs when a BSR is triggered by packet discarding or by long queueing times.

### Packet Discarding

Upon triggering of a BSR due to events relating to packet discarding, a UE may check if there is any pending SR previously triggered by the at least one LCH relating to the triggered BSR. If so, the UE may determine to perform one of the following behaviors: (1) Cancel the pending SR and stop the sr-ProhibitTimer, if it is running; (2) trigger another SR associating to a different SR configuration; (3) keep the pending SR but stop the sr-ProhibitTimer, if it is running; (4) keep the pending SR but switch the PUCCH configuration associated to this pending SR; or (5) reset the value of SR counter (e.g. to zero).

If, instead, there is no pending SR, the UE may determine to perform one of the following behaviors: (1) trigger an SR associating to a default or a special SR configuration (e.g., the related LCH may be associated to at least two SR configurations—one default configuration for the LCH and one special SR configuration for cases where the queueing delay has exceeded a threshold); (2) trigger an SR and use an alternative sr-ProhibitTimer (e.g., a timer having a value shorter than the default value); or (3) trigger an SR and use a different PUCCH configuration to signal this SR.

The behavior that the UE elects to take in any given scenario may depend on one or more of the following factors: (1) pre-configuration by the gNB; (2) UE implementation; or (3) the buffer status after packet discarding. For example, if the buffer is emptied after packet discarding, the UE can simply cancel the pending SR. Alternately, if some data is still in the buffer after packet discarding, the UE can keep the pending SR but stop the running sr-ProhibitTimer, so that the UE can signal the SR again more quickly.

### Long Queuing Delay

Upon triggering of a BSR (or other type of MAC CE) for delay information due to events relating to a long queueing time of buffered data and/or an amount of remaining time until a delivery deadline, the UE may check if there is any pending SR previously triggered by the at least one LCH related to the triggered BSR (or MAC CE element). If so, the UE may determine to perform one of the following behaviors: (1) cancel the pending SR and stop the sr-ProhibitTimer, if it is running; (2) trigger another SR associated to a different SR configuration; (3) keep the pending SR but stop the sr-ProhibitTimer, if it is running; (4) keep the pending SR but switch the PUCCH configuration associated to this pending SR; or (5) reset the value of SR counter (e.g., to zero).

If, instead, there is no pending SR, the UE may determine to perform one of the following behaviors: (1) trigger an SR associating to a default or a special SR configuration (e.g., the related LCH may be associated to at least two SR configurations—one default and one special SR configuration for cases where the queueing delay is too long); (2) trigger an SR and use an alternative sr-ProhibitTimer (e.g., a timer having a value shorter than the default value); (3) trigger a SR and use a different PUCCH configuration to signal this SR. The particular behavior that the UE determines to take may depend on one or more of the following: pre-configuration by the gNB; or UE implementation.

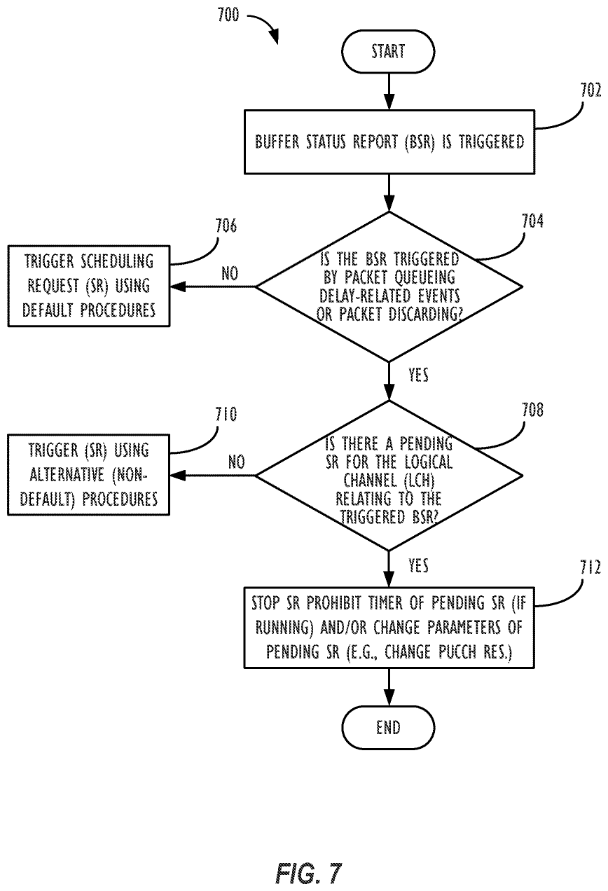

Turning now to FIG. 7, a flow diagram detailing a method of 700 handling scheduling request (SRs) when a BSR is triggered by specific events, such as packet discarding or long packet queueing delay, is illustrated, according to some aspects. As summarized above, method 700 may begin at block 702 when a BSR is triggered. Next, at block 704, a UE may evaluate whether the BSR is triggered by a packet queueing delay-related event or a packed discarding event. If the BSR has not been triggered by one of those two types of events (i.e., “NO” at block 704), the method 700 may proceed to block 706, wherein the UE may trigger an SR using default SR configuration and procedures.

If, instead, the BSR has been triggered by one of those two types of events (i.e., “YES” at block 704), the method 700 may proceed to block 708, wherein the UE may perform a second check to determine whether there is already a pending SR for the LCH relating to the triggered BSR. If there is not already a pending SR for the LCH (i.e., “NO” at block 708), the method 700 may proceed to block 710, wherein the UE may trigger an SR using alternative (i.e., non-default) SR configuration and procedures, such as the various options outlined in the sections immediately above. If, instead, there is already a pending SR for the LCH (i.e., “YES” at block 708), the method 700 may proceed to block 712, wherein the UE may stop the sr-ProhibitTimer of the pending SR (if it is still running) and/or change one or more parameters of the pending SR (e.g., changing its PUCCH resources).

In some embodiments, at block 708, the UE may also first determine whether there is a UL-SCH available for BSR transmission, and then the UE should only trigger the new SR if there is no such UL-SCH available. In still other embodiments, at block 712 the MAC can instruct the physical layer (PHY) to signal the SR directly.

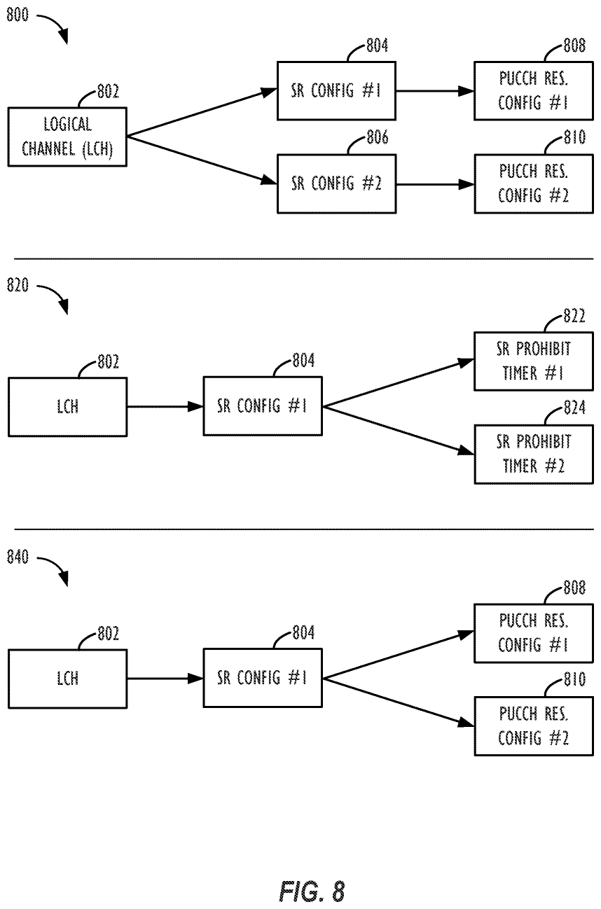

Turning now to FIG. 8, diagrams 800/820/840 detailing exemplary SR configuration for handling BSRs (or other MAC CEs) triggered by various types of events, such as packet discarding or long packet queueing delay, are illustrated, according to some aspects. As shown in diagram 800, a particular logical channel, LCH 802, may be associated with multiple SR configurations, e.g., SR configuration #1 (804) and SR configuration #2 (806). These SR configurations may be associated to different types of triggering events of BSRs or other MAC CEs. For example, SR Configuration #1 (804) may be used for BSR triggered by normal events that are not related to queueing delay or packet discarding, and SR Configuration #2 (806) (which may be different in one or more ways from SR Configuration #1) may be used for BSR triggered by events related to queueing delay (e.g., when the queueing delay of the buffered data has exceeded a threshold, or when the remaining time to delivery deadline is smaller than a threshold) or packet discarding. In diagram 800, SR Configuration #1 (804) is associated with a first PUCCH Resource Configuration #1 (808), and SR Configuration #2 (806) is associated with a second (e.g., different) PUCCH Resource Configuration #2 (810). The two SR configurations may also have other different SR parameters, such as different sr-ProhibitTimers, etc.

Turning to diagram 820, an embodiment is illustrated wherein a first SR prohibit timer #1 (822) and a second (e.g., different or shorter) SR prohibit timer #2 (824) may each be associated with the SR Configuration #1 (804), e.g., at different times and/or in response to different events or conditions detected at the UE. For example, SR prohibit timer #1 (822) may be used for BSR triggered by normal events that are not related to queueing delay or packet discarding, and SR prohibit timer #2 (824) may be used for BSR triggered by events related to queueing delay (e.g., when the queueing delay of the buffered data has exceeded a threshold, or when the remaining time to delivery deadline is smaller than a threshold) or packet discarding.

Finally, turning to diagram 840, an embodiment is illustrated wherein a first PUCCH Resource Configuration #1 (808) and a second (e.g., different) PUCCH Resource Configuration #2 (810) may each be associated with the SR Configuration #1 (804), e.g., at different times and/or in response to different events or conditions detected at the UE. For example, PUCCH Resource Configuration #1 (808) may be used for BSR triggered by normal events that are not related to queueing delay or packet discarding, and PUCCH Resource Configuration #2 (810) may be used for BSR triggered by events related to queueing delay (e.g., when the queueing delay of the buffered data has exceeded a threshold, or when the remaining time to delivery deadline is smaller than a threshold) or packet discarding.

### Exemplary Methods

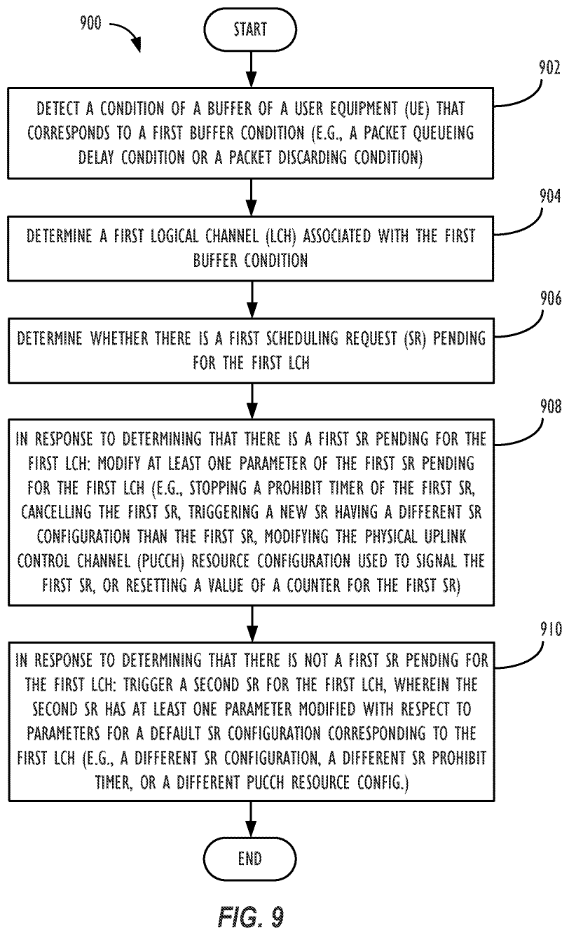

Turning now to FIG. 9, a flowchart 900 detailing a method of handling SRs when a BSR is triggered by packet discarding or long packet queueing delay is illustrated, according to some aspects. First, at block 902, a UE practicing the method of 900 may detect a condition of a buffer of the UE that corresponds to a first buffer condition (e.g., a packet queueing delay condition or a packet discarding condition). Next, at block 904, the UE may determine a first logical channel (LCH) associated with the first buffer condition. Next, at block 906, the UE may determine whether there is already a first scheduling request (SR) pending for the first LCH.

Next, at block 908, in response to determining that there is a first SR pending for the first LCH (i.e., a response of “YES” at block 906), the UE may modify at least one parameter of the first SR pending for the first LCH (e.g., stopping a prohibit timer of the first SR, cancelling the first SR, triggering a new SR having a different SR configuration than the first SR, modifying the Physical Uplink Control Channel (PUCCH) resource configuration used to signal the first SR, or resetting a value of a counter for the first SR, etc.).

Alternately, at block 910, in response to determining that there is not a first SR pending for the first LCH (i.e., a response of “NO” at block 906), the UE may trigger a second SR for the first LCH, wherein the second SR has at least one parameter modified with respect to parameters for a default SR configuration corresponding to the first LCH (e.g., a different SR configuration, a different SR prohibit timer, or a different PUCCH resource configuration, etc.).

Next, the method 900 may conclude, or the UE may simply return to block 902 and continue to detect whether and when a first buffer condition is again detected at the UE device, thereby re-performing method 900 until there is no longer a need for the UE to monitor its buffer conditions.

In some embodiments, the first buffer condition detected in block 902 may trigger a first buffer status report (BSR). In some such embodiments, the buffer includes traffic for a plurality of LCHs of one or more logical channel groups (LCGs), and the first buffer condition is associated with one or more LCHs of the plurality of LCHs (or it may be associated with any of the plurality of LCHs). In some embodiments, the first BSR reports information for only the first LCH, while, in other embodiments, the first BSR reports information for each LCH in the LCG that the first LCH is associated with.

### Additional Comments

The use of the connective term “and/or” is meant to represent all possible alternatives of the conjunction “and” and the conjunction “or.” For example, the sentence “configuration of A and/or B” includes the meaning and of sentences “configuration of A and B” and “configuration of A or B.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a user equipment (UE), the method comprising:
detecting a condition of a buffer of the UE that corresponds to a first buffer condition;
determining a first logical channel (LCH) associated with the first buffer condition;
determining whether there is a first scheduling request (SR) pending for the first LCH;
in response to determining that there is a first SR pending for the first LCH:
modifying at least one parameter of the first SR pending for the first LCH; and
in response to determining that there is not a first SR pending for the first LCH:
triggering a second SR for the first LCH, wherein the second SR has at least one parameter modified with respect to parameters for a default SR configuration corresponding to the first LCH.

2. The method of claim 1, wherein the first buffer condition triggers a first buffer status report (BSR) or a first Medium Access Control (MAC) Control Element (CE).

3. The method of claim 1, further comprising:
determining that the first buffer condition comprises a packet queueing delay condition or a packet discarding condition.

4. The method of claim 3, wherein the first buffer condition relates to packet queueing delay, and wherein the method further comprises:
sending packet queuing delay time information to a base station.

5. The method of claim 3, wherein the first buffer condition relates to packet queueing delay, and wherein the first buffer condition indicates at least one of the following conditions:
(a) that a queueing delay for buffered data has exceeded a threshold; or
(b) that an amount of remaining time until a delivery deadline for the buffered data is smaller than a threshold.

6. The method of claim 5, wherein the delivery deadline for the buffered data is derived based, at least in part, on a delay budget associated with one or more packets within the buffered data.

7. The method of claim 1, wherein modifying at least one parameter of the first SR pending for the first LCH comprises at least one of:
(a) stopping a prohibit timer of the first SR;
(b) cancelling the first SR;
(c) triggering a new SR having a different SR configuration than the first SR;
(d) modifying the Physical Uplink Control Channel (PUCCH) configuration used to signal the first SR; or
(e) resetting a value of a counter for the first SR.

8. The method of claim 7, wherein: (c) triggering a new SR having a different SR configuration than the first SR further comprises:
triggering a new SR having a shorter prohibit timer than a prohibit timer of the first SR.

9. The method of claim 1, wherein modifying at least one parameter of the first SR pending for the first LCH further comprises:
signaling the first SR at a next available opportunity, whether or not an SR prohibit timer for the first SR is still running.

10. The method of claim 1, wherein a Medium Access Control (MAC) layer instructs the UE to use the physical layer (PHY) to signal the first SR to a base station directly.

11. The method of claim 1, wherein the second SR having at least one parameter modified with respect to parameters for a default SR configuration comprises at least one of:
(a) the second SR having a different SR configuration than the default SR configuration;
(b) the second SR having a different SR prohibit timer configuration than the default SR configuration; or
(c) the second SR using a different PUCCH configuration than the default SR configuration.

12. The method of claim 11, wherein: (b) the second SR having a different SR prohibit timer configuration than the default SR configuration further comprises:
the second SR having a shorter SR prohibit timer configuration than an SR prohibit timer configuration of the default SR configuration.

13. The method of claim 2, wherein triggering the second SR further comprises:
triggering the second SR to obtain an uplink (UL) resource allocation for the first BSR.

14. The method of claim 1, wherein triggering the second SR further comprises:
triggering the second SR in response to determine there is no Uplink Shared Channel (UL-SCH) available for the UE to use.

15. The method of claim 1, wherein the first buffer condition is based on at least one of:
(a) a determination of whether all protocol data units (PDUs) in a buffered PDU set are required by an application;
(b) a comparison of a remaining time until a delivery deadline of buffered data to a predetermined threshold;
(c) a comparison of a queuing time of buffered data to a predetermined threshold;
(d) a comparison of an amount of buffered data to a predetermined threshold;
(e) an importance or priority associated with a buffered PDU set;
(f) whether packet discarding is configured for a buffered PDU set or a radio bearer corresponding to the buffered PDU set;
(g) whether a packet discarding event has occurred;
(h) a comparison of an amount of discarded data to a predetermined threshold;
(i) a comparison of an amount of remaining buffered data after a packet discarding event has occurred to a predetermined threshold; or
(j) a determination of whether an amount of buffered data remaining after a packet discarding event is zero.

16. The method of claim 1, wherein the buffer includes traffic for a plurality of LCHs of one or more logical channel groups (LCGs), and wherein the first buffer condition is associated with one or more LCHs of the plurality of LCHs or is associated with any of the plurality of LCHs.

17. The method of claim 2, further comprising:
transmitting the first BSR to a base station.

18. The method of claim 17, wherein: the first BSR reports information for:
(a) only the first LCH; or
(b) each LCH in a logical channel group (LCG) that the first LCH is associated with.

19. (canceled)

20. A user equipment (UE) device comprising: a receiver; a transmitter; and a processor configured to perform operations comprising:
detecting a condition of a buffer of the UE that corresponds to a first buffer condition;
determining a first logical channel (LCH) associated with the first buffer condition;
determining whether there is a first scheduling request (SR) pending for the first LCH;
in response to determining that there is a first SR pending for the first LCH:
modifying at least one parameter of the first SR pending for the first LCH; and
in response to determining that there is not a first SR pending for the first LCH:
triggering a second SR for the first LCH, wherein the second SR has at least one parameter modified with respect to parameters for a default SR configuration corresponding to the first LCH.

21. (canceled)

22. A baseband processor configured to cause a user equipment (UE) to perform operations comprising:
detecting a condition of a buffer of the UE that corresponds to a first buffer condition;
determining a first logical channel (LCH) associated with the first buffer condition;
determining whether there is a first scheduling request (SR) pending for the first LCH;
in response to determining that there is a first SR pending for the first LCH:
modifying at least one parameter of the first SR pending for the first LCH; and
in response to determining that there is not a first SR pending for the first LCH:
triggering a second SR for the first LCH, wherein the second SR has at least one parameter modified with respect to parameters for a default SR configuration corresponding to the first LCH.
